(19) United States
(12) Patent Application Publication
(10) Pub. No.: US 2004/0188463 A1
(43) Pub. Date: Sep. 30, 2004

(54) Dispenser bag drainage method and structure

(76) Inventor: Hanlon Harris JR., Mt. Ephraim, NJ (US)

Correspondence Address: William L. Muckelroy, Esq., P.C., Ewing Professional Park, 1901 N. Olden, Suite 3A, Trenton, NJ, 08618, US

(21) Appl. No.: 10/807,008

(22) Filed: Mar. 23, 2004

Related U.S. Application Data
(60) Provisional application No. 60/457,721, filed on Mar. 26, 2003.

(51) Int. Cl. B65D 35/56; B67D 3/00

(52) U.S. Cl. 222/105

(57) ABSTRACT

A dispenser bag containing bulk liquid food is provided with a truncated bottom with a bottom seal located below an adjacent normally closed horizontally mounted dispenser spout. The space between the spout and the bottom seal assists in accumulating any sediment in the liquid food. The spout has an encircling outer rim which directs the flow of liquid food vertically downward. By tapering the dispenser bag vertically downward toward the dispenser spout on both or either side thereof improved dispensing of the liquid food in the bag is provided and waste left in conventional untapered bags with horizontally dispensing spouts located below the horizontal bottom seal is reduced. A method is further provided for eliminating or reducing the dispensation of sediment by capturing same below the spout, the spout being oriented slightly above the base of the conical structure formed by truncation of the lower part of the dispenser bag.

A priority date of Mar. 26, 2003 is claimed based on a filed related provisional patent application in the United States Patent Office, Ser. No. 60/457,721, on Mar. 26, 2003 disclosing the subject herein.

### BACKGROUND OF THE INVENTION

1. Field of the Invention

The invention relates to cost-saving methods and techniques for providing and vending liquid foods in the wholesale channel of commerce and dispensing liquid foods such as milk to users in the retail channel of commerce employing bulk packaging of the dispensed liquid foods and a console dispenser with a selectively actuated spout for dispensing liquid foods into a receptacle such as a cup.

2. Description of the Prior Art

For years dairy products such as milk, cream, half and half, and the like, for example, have been made available at retail coffee bars where brewed coffee, tea, and the like were sold in individual sized containers. The retailers, to reduce their labor and other costs and to increase efficiency, have subcontracted the dairy aspect of this business to dairy product dispensing specialists to maintain the supply of liquid dairy items, including flavored milks, orange juice, and the like and to provide dispensers, and maintain sanitation and health safety of these dispensed products.

The inventor during the development of various dispenser designs, discovered the improved spout of this invention.

In addition, the inventor noticed that the quality of the dispensed liquid product at the beginning of the dispensing cycle was markedly better than the quality at the end of this dispensing cycle. He discovered that due to the rectangular shape of the gravity fed collapsible dispenser bag, liquid accumulated and stagnated at the bag's lower corners toward the end of the dispensing cycle. The flow of liquid generally tends to be down the central portion of the bag allowing liquid at the lower corners to linger.

In the bags containing chocolate milk and non-pulp free orange juice, sedimentation occurred occasionally and was dispensed. Moreover, he discovered that in the prior art bags that had been tapered, the spout was placed at the bottom of the bag. Clogging of a spout due to sediment from chocolate milk and fresh orange juice with pulp was likely. Experimenting yielded a horizontal mounted spout with a modified rim to insure that the liquid food product would flow downward as it exits rather than horizontally.

The liquid food that lingered in the corners amounted to a measurable economically significant percentage of the total volume of a bag, for example, about 1%, when several thousand units were involved. This residual amount not only degraded the quality of the liquid at the end of the dispensing cycle, it was discarded when a new replacement bag was installed in a dispenser a significant economic waste factor. Thus, the inventor recognized that a solution to this residual amount problem would (i) improve the quality of the dispensed product and (ii) decrease the cost of product to the wholesaler by about 1%.

In employing the novel spout with a vertically downward diverter, splashing on dispensation of product was avoided and customer satisfaction was improved.

In the case of 5-12 liter rectangular bags with a dispenser spout centrally located near the bottom perimeter, the improved drainage method requires the step of sealing off at least one corner obliquely from the spout area to transform the bags into pentagonal containers.

Of particular note is U.S. Pat. No. 4,513,885 entitled “Dispenser Having a Flexible Fluid Container and a Rotor Compressible Fluid Discharge Tube” issued to Hogan on Apr. 30, 1985. FIGS. 10 and 11 of Hogan illustrate a dispenser bag with a tapered lower half that is similar in some respects to the novel bag disclosed. However, the spout 56 of Hogan is vertically disposed, then elongated and bent to horizontal as subsequently disclosed in FIGS. 14 and 15. Thus, no collection pouch for sediment exists in the Hogan structure.

### SUMMARY OF THE INVENTION

A novel improvement in the structure and method of dispensing liquid food from a combination of a flexible wall plastic bag adapted as a closed receptacle for liquid food and a self-closing dispensing spout comprising the step of gravity enhanced mingling, combined with the step of sealing off preferably each corner in a straight line at an angle extending obliquely from the spout area whereby the amount of stale fluid remaining in the bag at the end of the dispensing cycle as the contents of the bag are more fully discharged is diminished. The bag with one or more corners obliquely sealed off is uniquely combined with a spout having a horizontal axis wherein the spout has a fluid conduit with a valve orifice therethrough, a flow control member within the valve body which is displaceable transversely to the horizontal axis from a first position in which the flow control member obstructs the flow of fluid through the valve orifice to a second position in which the flow control member does not obstruct the flow of fluid through the valve orifice. The flow control member is deflected when the valve member is displaced to its open position. The novel bag and orifice structure directs the fluid product to flow orthogonally through the valve orifice downwardly at a right angle to the horizontal axis when the flow control member is actuated and displaced from its closed position such that the vertical reactionary vector flow component is substantially greater than for obliquely discharged liquids causing the fluid in the vicinity of the spout to mingle more effectively.

According to a method embodied in the present invention, for a fluid food product contained in a rectangular flexible bag there is provided a method of reducing discarded product waste, of avoiding dispensing sediment, of accumulating sediment, of diminishing accumulated product residue combined with a method of avoiding a horizontal dispersal of liquid food via a horizontally disposed spout. The novel method comprises the steps of:

Sealing off a substantial part of at least one corner of the rectangular flexible bag whereby a lower part of the bag is truncated;

Orienting a dispensing spout in the lower part of the truncated bag;

Connecting the dispensing spout horizontally to the bag;

Forming a tapered pouch for collecting sediment between a bottom edge of the bag and the spout; and,

Inserting a rim segment in the lowermost front portion of the spout to block forwardly horizontally flowing fluid whereby fluid is directed vertically downward.

The above features and advantages of the present invention will become apparent from the following description read in conjunction with the accompanying drawings, in which like reference numerals generally designate the same elements.

### BRIEF DESCRIPTION OF THE DRAWINGS

FIG. 1A is a front view of a hexagonal embodiment of the invention;

FIG. 1B is a rear view of the hexagonal embodiment of the invention; and,

FIG. 1C is a left side sectional view of the hexagonal embodiment shown in FIGS. 1A and 1B.

FIG. 2A is a front view of a pentagonal embodiment of the invention;

FIG. 2B is a rear view of the pentagonal embodiment of the invention; and,

FIG. 2C is a left side sectional view of the pentagonal embodiment shown in FIGS. 2A and 2B.

FIG. 3A is a front view of a quadrilateral embodiment of the invention;

FIG. 3B is a rear view of the quadrilateral embodiment of the invention; and,

FIG. 3C is a right side sectional view of the quadrilateral embodiment of the invention shown in FIGS. 3A and 3B.

FIG. 4A is a left side cross sectional view of a prior art spout taken along the is plane 4A shown in FIG. 4B; and,

FIG. 4B is a front view of the prior art spout.

FIG. 5A is a left side cross sectional view of the novel improved spout depicted along the plane 5A shown in FIG. 5B; and,

FIG. 5B is a front view of the improved spout.

### DESCRIPTION OF THE PREFERRED EMBODIMENT

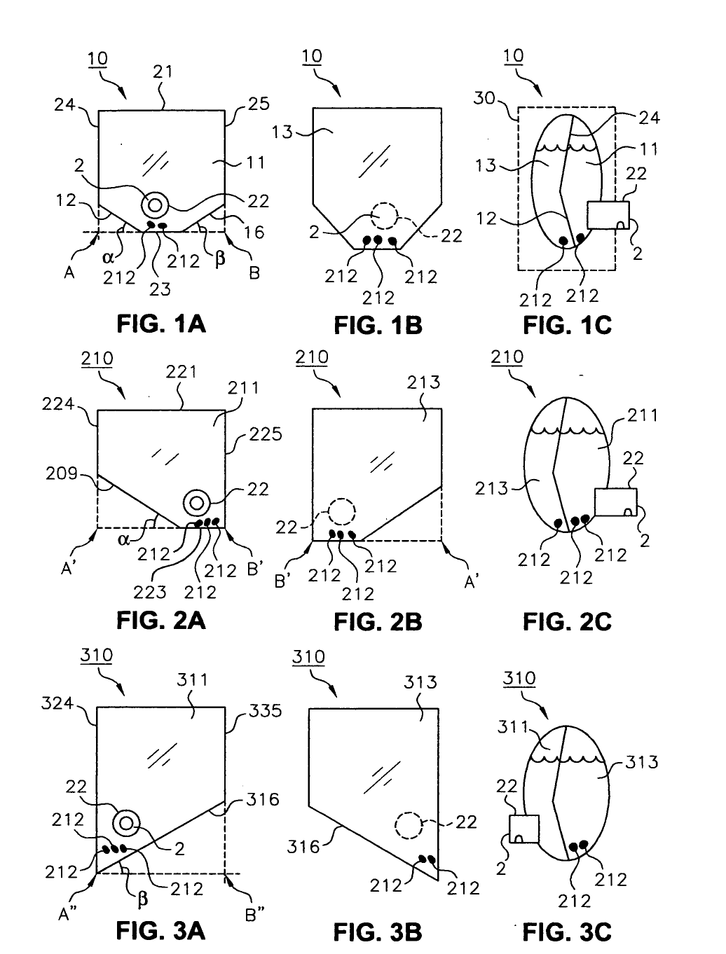

There is shown in FIG. 1a a front view of a rim lip segment 2 attached to a hexagonal containment bag 10 made of plastic, for example. The bag 10 is made of a hexagonal front panel 11, a first left oblique seal 12, and a hexagonal rear panel 13 attached to an assembly of a dispenser valve and spout 22. A novel aspect of the spout 22 is the rim lip segment 2 shown in detail in FIGS. 5A and 5B in accordance with the invention. Sediment 212 is shown as accumulated below the spout 22.

Referring to FIG. 1b there is shown a rear view of the bag 10 with the spout 22 combined with the lip segment 2 visible through the plastic bag 10. Additional sediment 212, sediment particles for example, are shown accumulated below the spout 22.

Shown in FIG. 1c is a side view of the bag 10 housed inside a dispenser housing 30 with the rim segment 2 and spout 22 extending through the front of the dispenser housing 30. More detail of the bag 10 is illustrated. The bag 10 is comprised of front and back rectangular panels 11 and 13, joined and sealed at each adjacent edge to form a four sided container with sealed edges 12, 16, 24, and 25 suitable for and adapted hermetically to hold a liquid such as milk, cream or half and half, for example. As shown in FIG. 1C the front panel 11 is equipped with the novel spout 22, which is a combination of a horizontally oriented normally closed spigot and a novel rim segment 2 to direct fluid flow vertically downward according to the invention.

Referring again to FIG. 1a, in this embodiment for the novel invention, the content of hexagonal bags range from 5-12 liters with dispenser spout 22 centrally located near but above the bottom seal 23 of the perimeter. In the preferred embodiment shown, the improved drainage method requires the step of sealing off each of the corners A and B at angles α and β, respectively, to form oblique seals 12 and 16 extending obliquely away and upwards from the spout 22 thereby facilitating the step of gravitationally forcing a flow of the sediment 212, if any, below the spout 22 and in the vicinity of the bottom seal 23.

The angles α and β illustrated in FIG. 1A of the drawing range from 48 degrees to 65 degrees for bags adapted to hold from 5 to 12 liters wherein the width of the bag 10 from the seal 24 to the seal 25 is approximately 43 centimeters, for example. In the presented preferred embodiment with the novel spout 22 in the center near the bottom edge 23 as shown, the angles α and β are about equal.

For dispensers with a pentagonal bag 210 as shown in FIG. 2A, the spout 22 is positioned at the left side away from the pentagonal left seal 224 and near the pentagonal right seal 225. In this embodiment the oblique seal 12 and angle α are eliminated.

For a quadrilateral dispenser 310 as shown in FIG. 3A the novel spout 22 is located between a quadrilateral oblique seal 316 and a quadrilateral left seal 324. Thus, the oblique seal 16 and the angle β associated with the bag 10 shown in FIG. 1A are eliminated.

For dispensers adapted to receive a bag with dual spouts or multiple spouts, the multiples of the oblique seals 12 and 16 are used to create triangular sealed spaces between adjacent spouts.

In the 5-liter bag with the spout in the center near the bottom side of a rectangular bag, for optimum flow of any sediment it is preferred that the angle α is about 68 degrees and that the width is about 43 cm. In the 12-liter bag with the spout in the center near the bottom side of a rectangular bag, it is preferred that the angle a is about 68 degrees and that the width is about 46 cm.

The first preferred embodiment has been disclosed as a hexagonal bag 10 with a novel modified spout 22 centrally located preferentially above the bottom seal 23 of the bag 10 wherein the bag 10 is used by inserting into a hollow box shaped dispenser housing 30 having an aperture adapted to receive and hold in a horizontal position the bag spout 22 such that the rim segment 2 directs fluid flowing through the spout 22 in a vertical downward stream. Thus, the rim segment 2 prevents liquid food flowing from the spout 22 from splashing into a consumer's receptacle by avoiding lateral outward flow.

The spout 22 can be located at either the lower left or lower right corner of a food containment bag such as the bag 210 or the bag 310, respectively. The space below the spout 22 can be terminated with a horizontal seal below such as the bottom seal 223 shown for the bag 210. The angular space at A” shown accumulating sediment 212 in FIG. 3A provides superior sediment accumulating function over the truncated corner space near B′ shown in FIG. 2A.

In this embodiment, the step of sealing off is applied to only the one corner A or B opposite the corner where the spout is located. The selected single corner A or B is sealed off in a straight line at an angle α or β extending obliquely upward away from the spout area to diminish the amount of stale fluid remaining in the bag at the end of the dispensing cycle as the contents of the bag are more fully discharged. There is shown in FIG. 1a a front view of a plastic containment bag 10 with a dispenser valve and spout assembly 22 in accordance with the invention. Shown in FIG. 1b is a side view of the bag 10 housed inside a dispenser housing 30 with the valve and spout assembly 22 extending through the front of the dispenser housing 30. The bag 10 is comprised of two equal front and back rectangular panels 11 and 13, joined and sealed at each adjacent edge to form a four sided container suitable for and adapted for holding a liquid such as milk, cream or half and half, for example. The bag 10 has a top edge 21, a bottom edge 23, a left edge 24, and a right edge 25. The front panel is equipped with the assembly 22, which is a combination of a horizontally oriented spout, and a normally closed valve assembly made in accordance with the known prior art related to the invention.

Referring to FIG. 2a, there is shown another embodiment for the novel invention with the dispenser spout 22 asymmetrically located in the right corner B′ near a bottom edge 223 of a bag 210. In this preferred embodiment, the improved drainage method requires the step of sealing off a corner A′ in a straight line 209 and/or 12 at an angle α. The line 209 extends obliquely away and upwards from the spout and valve assembly 22. In the embodiment for the bag 210 with the assembly 22 located near the right edge 225 and above the bottom edge 223 as shown in FIG. 2a, the angle α is preferably at least 45 degrees.

The second preferred bag 210 is a pentagon with a spout asymmetrically located above but near the bottom edge 223 of the bag. This allows the bottom edge 223 to trap sediment. The selected single corner A′ is sealed off in a straight line at an angle α extending obliquely upward away from the spout area. This tapering of the bag 210 serves to diminish the amount of stale fluid remaining in the bag 210 otherwise at the corner A′ at the end of the dispensing cycle. Hence, the contents of the bag 210 are more fully discharged.

Thus, there is shown in FIG. 2a a front view of a plastic containment bag 210 with a dispenser valve and spout assembly 22 in accordance with the invention. Shown in FIG. 2b is a rear view of the bag 210 with the assembly 22 showing through the transparent rear panel 213. Shown in FIG. 2c is a side view of the bag 210 with the valve and spout assembly 22 extended horizontally. The bag 210 is also comprised of two equal front and back rectangular panels 211 and 213, joined and sealed at each adjacent edge to form a five sided container suitable for and adapted for holding a liquid such as milk, cream or half and half, for example. The bag 210 has a top edge 221, a bottom edge 223, a left edge 224, and a right edge 225. The front panel is equipped with the assembly 22, which is a combination of a horizontally oriented spout, and a normally closed valve assembly attached in accordance with the known prior art related to the invention but improved with the novel lip member 2 which insures that the dispensed fluid is directed vertically downward.

Referring again to FIG. 3A, there is shown yet another preferred embodiment of the novel invention, for example the bag 310, constructed in accordance with the novel invention with the dispenser spout 22 asymmetrically located above and to the right of the left corner A″ and near the slanted bottom edge 316 associated with the bag 310. Hence, in the preferred embodiment of the method invention, the improved drainage method requires the step of sealing off the bottom of the bag 310 at the corner A″ in a straight line at an angle β to form a sealed edge 316. The edge of the seal 316 is formed by a step of extending a seal obliquely away from the point A″ located below the spout 22 upwards above the spout 22. The spout 22 is located near the lowermost part of the left edge 324 and above the bottom edge 316 as more fully shown in the rear view depicted in FIG. 3B and in the left side view in FIG. 3C.

The complementary angular pocket created by the complement to the angle β of FIG. 3A is preferably about 60 degrees and creates what is called a “flow over” and “overflow capture pocket” at the corner A″ below the spout 22. The “overflow capture pocket” symbiotically allows sediment to accumulate below the spout 22 and also retards an accumulated stale pocket of fluid to be minimized and not pass into and thru the assembly 22. This symbiosis attributable to the structure shown is especially present when the fluid is orange juice with pulp or chocolate milk or flavored milk, made from a sweetened flavored syrup, for example.

In particular, the third preferred bag 310 is a quadrangle with the spout 22 asymmetrically located above but near the bottom corner A″ of the bag 310. This allows the corner A″ to trap sediment and accumulate sediment which would otherwise enter the assembly 22. The selected corner A″ is sealed off to form part of the sealed edge 316. The sealed edge 316 is a straight line at the angle β extending obliquely upward away from the spout area. This optimal as symmetrical tapering to form the bag 310 serves to isolate stale fluid below the spout assembly 22. Hence, the contents of the bag 310 are more fully discharged and any sediment accumulates below the assembly 22 as shown in FIG. 3C.

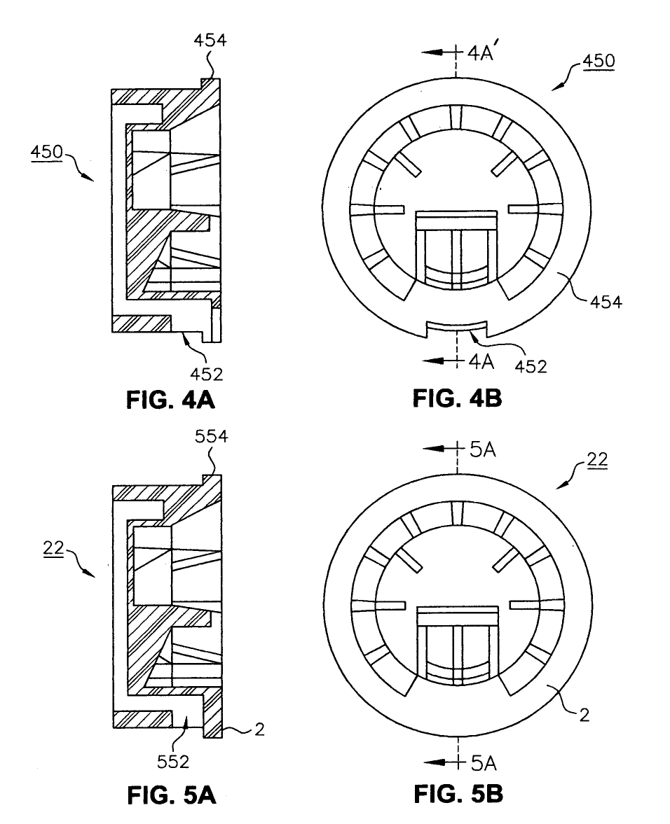

Thus, there is shown in FIG. 3A a front view of a novel plastic containment bag 310 with a dispenser spout 22 in accordance with the invention. Shown in FIG. 3B is a rear view of the bag 310 with the spout 22 showing through the transparent rear panel 313. Shown in FIG. 3C is a right side view of the bag 310. The bag 310 is made of two equal front and back rectangular panels 311 and 313, joined and sealed at each adjacent edge to form a four sided container adapted for holding a liquid food. The bag 310 has a top edge or seal, a bottom edge comprised of the seal 316, a left edge comprised of the seal 324, and a right edge comprised of the seal 335. The front panel is equipped with the spout 22 modified in accordance with FIGS. 5A and 5B of the drawing. The spout 450 of the prior art is shown in FIGS. 4A and 4B. There is shown a plenum 452 or space in the lowest segment of a retaining member or rim 454. The plenum 452 allows fluid foods to flow through the spout 450 into the plenum 454 and then horizontally outward since the plenum 452 opens horizontally as shown in FIG. 4B.

Modifying the spout 450 as shown in FIGS. 5A and 5B by changing the rim 454 with an opening to a fully closed rim segment 2 which creates a vertically downward opening plenum 552 which allows fluid foods to flow through the spout 22 into the plenum 552 and then vertically downward.

Without the benefit of a spout improved with the novel fully closed rim segment 2 which insures that the dispensed fluid is directed substantially vertically downward instead of horizontally and then downward as with a conventional prior art spout 450 shown in FIGS. 4a and 4b, the sediment 212 has an opportunity to accumulate in the plenum 452 at the forward and side edges thereof.

Shown in FIG. 4a is a side cross-sectional view of the prior art valve 450. The cross-section is taken along the plane 4A-4A′ shown in a front view of valve 450 shown in FIG. 4b. The essential aspect of the prior art valve 450 is a plenum 452 formed where a lip section of the rim 454 is removed. This structure is the customary structure used in the prior art but allows dispensed fluid to flow horizontally outward in front of the rim 454 and valve 450.

The additional novel improvement to this structure is shown in FIGS. 5a and 5b. In FIG. 5a there is shown an improved rim 554 wherein the plenum 452 has been modified to a plenum 552 wherein the rim 554 surrounds the circumference of the valve 22 and thereby restricts horizontal flow. Flow from the improved plenum 552 is downward due to horizontal flow being blocked by the lip 2. In the art the removed lip 2 is sometimes referred to as an undercut and is removed in the known prior art to provide unrestricted fluid flow.

In each novel embodiment described it is also preferred that all the parts be made from a suitable synthetic resin, preferably polypropylene. However, the scope of the invention includes valves and spouts made of any material because the actuator for the spout may be modified and exemplified in multiple parts for re-usable dispenser valves and spouts which convey fluid food product from non-disposable refillable bags or alternative refillable disposable bags and containers. Moreover, although recognized as more costly, it may be useful in some circumstances to employ curving or a curvature or non-linearity to the seals 12 and/or 16, for example, or the seals 209,223, or 316.

The invention having now been fully described, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalency of the claims and/or the doctrine of equivalents are intended to be embraced therein.

### Parts List

2 rim lip segment

10 hexagonal containment bag

11 hexagonal front panel

13 hexagonal rear panel

12 first left oblique seal

16 first right oblique seal

21 first top seal

22 normally closed spout

23 first bottom seal

24 first left seal

25 first right seal

30 dispenser housing

209 pentagonal oblique seal

210 pentagonal containment bag

211 pentagonal front panel

212 sediment

213 pentagonal rear panel

221 pentagonal top seal

223 pentagonal bottom seal

224 pentagonal left seal

225 pentagonal right seal

310 quadrilateral containment bag

311 front quadrilateral panel

313 back quadrilateral panel

316 oblique quadrilateral seal

324 left quadrilateral seal

335 right quadrilateral seal

450 prior art spout

452 prior art plenum

454 prior art rim

552 improved plenum

554 improved rim

What is claimed is:

1. In a rigid dispenser housing having therein a flexible liquid food container, the improvement comprising a combination of a liquid food fluid-tight dispensing bag having a dispensing spout wherein a liquid food is vertically downwardly discharged from the dispensing bag, the bag being made of a front and rear pair of sheets of flexible liquid impervious material having left and right vertical marginal edges secured by sealing along their marginal edges to form a downwardly tapered sealed fluid-tight container, the sheets being sealed along downwardly inclined and converging seal lines to form a conical shaped lower end of the sealed bag wherein liquid food gravitates downwardly when the dispenser bag is installed within the dispenser housing.

2. The dispenser bag according to claim 1 further comprising the further improvement of a horizontally oriented dispensing spout sealingly attached to the front sheet and spaced slightly above a bottom marginal seal whereby sediment gravitates to the bottom marginal seal and accumulates at the bottom marginal seal and remains undispensed.

3. The dispenser bag according to claim 2 further comprising the further improvement wherein the horizontally oriented dispensing spout comprises a blocking means for blocking horizontal flow of fluid food from the spout and directing said flow of fluid from the spout vertically downwardly away from the spout.

4. A dispenser housing having therein liquid food comprising a liquid food dispensing containment means for containing liquid food, a dispensing spout oriented wherein the liquid food is vertically downwardly discharged sediment-free from the containment means directly into a receptacle, the containment means being downwardly tapered, sealed, and air-tight wherein the liquid food gravitates downwardly and out through a horizontal dispensing spout and wherein sediment gravitates downwardly inside the containment means below the dispensing spout.

5. A dispensing method for avoiding sediment in a liquid food dispensed from a flexible plastic dispenser bag having an upper part, a lower part and a bottom edge, the dispenser bag being fluid-tight having sealed edges and a dispenser spout attached to the lower part comprising the steps of:
(a) downwardly tapering the lower part of the dispenser bag adjacent to the dispenser spout;
(b) horizontally orienting and attaching the dispenser spout above the bottom edge;
(c ) forming a trough below the horizontally oriented dispenser spout;
(d) catching sediment in a space between the spout and the bottom edge as fluid food flows downwardly to the lower part of the dispensing bag; and,
(e) accumulating sediment in said space.

6. The method according to claim 5 further comprising the blocking step of blocking fluid food flowing through the dispensing spout from horizontally exiting the spout.

7. The method according to claim 6 wherein the blocking step further comprises directing said flowing fluid food vertically downward.

8. The method according to claim 7 wherein the blocking step further comprises extending a rim segment in front of said flowing fluid food, the rim segment being extended circumferentially entirely around the dispensing spout.

9. The dispenser bag of claim 3 wherein the front and rear pair of sheets of flexible liquid impervious material are hexagonal, the sheets having left and right vertical upper marginal edges connected respectively to left and right non-vertical oblique marginal edges secured by sealing to form a downwardly tapered sealed fluid-tight hexagonal container having a horizontal bottom seal in between the left and right non-vertical sealed marginal wherein liquid food gravitates downwardly to the horizontal bottom seal whereby any sediment in the fluid food accumulates near the horizontal bottom seal.

10. The dispenser bag according to claim 9 wherein the bag and spout are made of plastic.

11. The dispenser bag according to claim 10 wherein the plastic is polypropylene.

12. The dispenser bag according to claim 11 wherein the dispensing spout is normally closed.

13. The dispenser bag according to claim 12 wherein the joined edges of the bag are heat sealed.

14. The invention of claim 4 wherein the liquid food containment means is a dispensing bag with a sealingly attached dispensing spout, the bag comprising rectangular front and rear panels sealingly connected at their edges, the spout being located in the front panel above a bottom edge of the front panel, the improvement comprising at least one oblique seal located on one side of the dispenser spout extending from a bottom seal where the panels are sealed together to a vertical seal where the panels are sealed together, upwards away from the spout, the spout being located on the front panel, the spout being sealingly attached and horizontally oriented on the front panel, the spout having a vertically downwardly fluid directing means for blocking horizontal flow of fluid food from the spout.
